(19) United States
(12) Patent Application Publication
(10) Pub. No.: US 2025/0299624 A1
(43) Pub. Date: Sep. 25, 2025

(54) Electronic Display Self-Coupling Cross Talk Compensation

(71) Applicant: Apple Inc., Cupertino, CA (US)

(72) Inventors: Jongyup Lim, San Jose, CA (US); Shyuan Yang, San Jose, CA (US); Pubudu Galwaduge, Fremont, CA (US); Hyunwoo Nho, Palo Alto, CA (US); Kingsuk Brahma, Mountain View, CA (US); Ricardo A Peterson, Fremont, CA (US); Jie Won Ryu, San Jose, CA (US); Raymond Liou, Fremont, CA (US)

(21) Appl. No.: 19/049,940

(22) Filed: Feb. 10, 2025

Related U.S. Application Data
(60) Provisional application No. 63/567,366, filed on Mar. 19, 2024.

(51) Int. Cl. G09G 3/32; G09G 3/3225

(52) U.S. Cl. CPC G09G 3/32; G09G 3/3225; G09G 2310/08; G09G 2320/0209; G09G 2320/0285

(57) ABSTRACT

Electronic devices, displays, and methods are provided for compensating image data to account for self-coupling by display pixels on a shared data line. An electronic display may include an electronic display panel with lines and columns of display pixels. Each column of display pixels may be coupled to a respective data line. Display driver circuitry may adjust image data associated with the display pixels to account for coupling between the display pixels and the respective data lines.

### CROSS-REFERENCE TO RELATED APPLICATIONS

This application claims priority to U.S. Provisional Application No. 63/567,366, filed Mar. 19, 2024, which is incorporated by reference herein in its entirety.

### SUMMARY

The present disclosure relates to compensating image data for display on an electronic display to mitigate self-coupling between display pixels on the electronic display that share a common data line.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Numerous electronic devices—such as computers, mobile phones, portable media devices, tablets, televisions, virtual-reality headsets, and vehicle dashboards, among many others—often include electronic displays. To display an image, an electronic display may control light emission of its display pixels based on corresponding image data for the display pixels. By emitting light in various brightness values at different display pixels according to the image data, the electronic display may present an image.

An electronic display is often arranged in rows and columns of display pixels. Each column of display pixels is attached to a data line that is shared by all display pixels of that column. The display pixels are programmed row by row by scan and/or sampling signals that cause each display pixel of the row to briefly connect to the respective data line. In this way, the display pixels sample the image data (e.g., a particular voltage) that is carried on the data line and then store the image data in the display pixels. Because a data line is shared by other display pixels of the same column, however, differences in the image data propagating on the data line could affect the image data that has been stored in a display pixel. This may result in an image artifact in which the brightness of one display pixel could be affected by the image data programmed into subsequent display pixels of the same column due to the shared data line.

To reduce or eliminate these image artifacts, image data for a target display pixel may be adjusted to compensate for differences in image data for subsequently programmed display pixels sharing the same data line. For example, self-coupling cross talk compensation circuitry in an electronic display may receive multiple lines of pixel data. Line-by-line pixel data differences may be sequentially computed. The pixel data differences may be scaled based on the programming time of each line in relation to the line of the target pixel data and these values may be summed. This is because self-coupling cross talk may be less efficacious as time goes on. Thus, the pixel data differences may be scaled to have greater weights the sooner these subsequent pixel data values are to be programmed. A pixel data adjustment to compensate for self-coupling effects may be determined based on the sum of the scaled pixel data differences. The pixel data adjustment may be applied (e.g., added) to the target pixel data. When this compensated target pixel data is programmed into the target display pixel, after settling, the target display pixel may have reduced or may be substantially free of self-coupling cross talk image artifacts.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device with an electronic display;

FIG. 2 is a front view of a handheld device representing an example of the electronic device of FIG. 1;

FIG. 3 is a front view of another handheld device representing another example of the electronic device of FIG. 1;

FIG. 4 is a perspective view of a notebook computer representing an example of the electronic device of FIG. 1;

FIG. 5 illustrates front and side views of a wearable electronic device representing another example of the electronic device of FIG. 1;

FIG. 6 is a block diagram of an electronic display having an array of display pixels controlled by display driver circuitry that includes self-coupling cross talk compensation circuitry;

FIG. 7 is a circuit diagram of a display pixel during image data programming;

FIG. 8 is a circuit diagram of the display pixel after image data programming but before emission when the display pixel is vulnerable to self-coupling cross talk on a data line shared by other display pixels;

FIG. 9 is a circuit diagram of the display pixel during an emission phase;

FIG. 10 is a schematic diagram of an ideal case of a first example of electronic display programming;

FIG. 11 is a schematic diagram of a case of the first example of electronic display programming involving self-coupling cross talk without compensation;

FIG. 12 is a schematic diagram of an ideal case of a second example of electronic display programming;

FIG. 13 is a schematic diagram of a case of the second example of electronic display programming involving self-coupling cross talk without compensation;

FIG. 14 is a timing diagram illustrating image data stored on a display pixel of one row affected by self-coupling cross talk due to pixel data from subsequently programmed rows;

FIG. 15 is a block diagram of self-coupling compensation circuitry; and

FIG. 16 is a flowchart of a method for performing self-coupling compensation.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

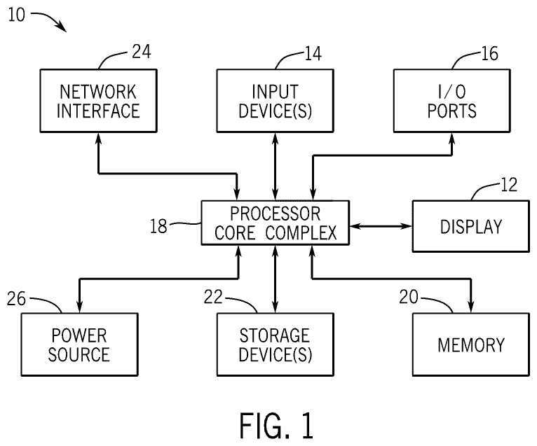

An electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, and a power source 26 (e.g., power supply). The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

The electronic display 12 may include a display panel with an array of display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW arrangement).

The electronic display 12 may display an image by controlling light emission from its display pixels based on image data associated with corresponding display pixels in the image. In some embodiments, image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on image data generated by the processor core complex 18, or the electronic display 12 may display frames based on image data received via the network interface 24, an input device, or an I/O port 16.

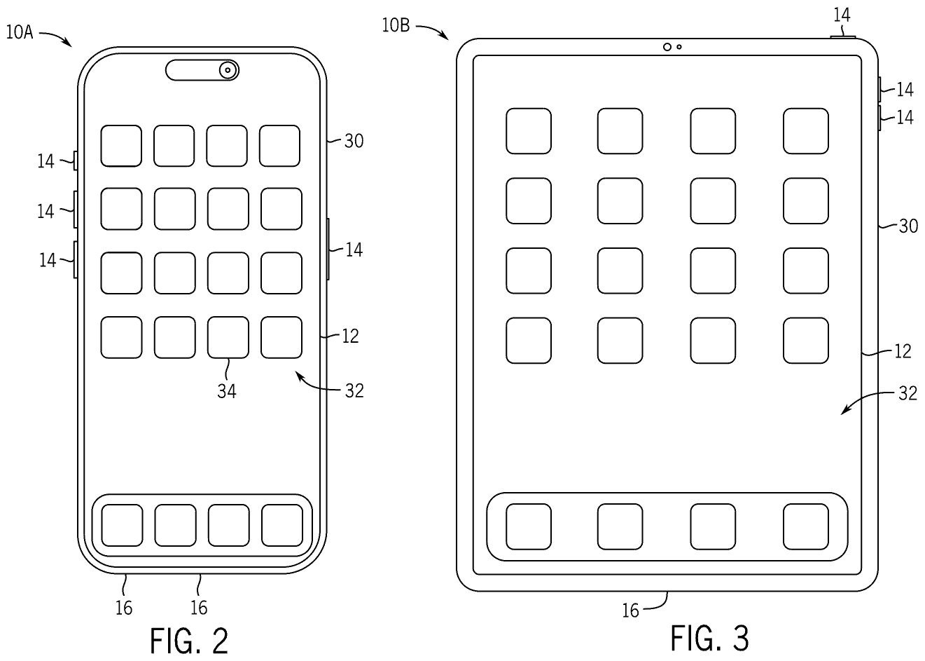

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as any IPHONE® model available from Apple Inc.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

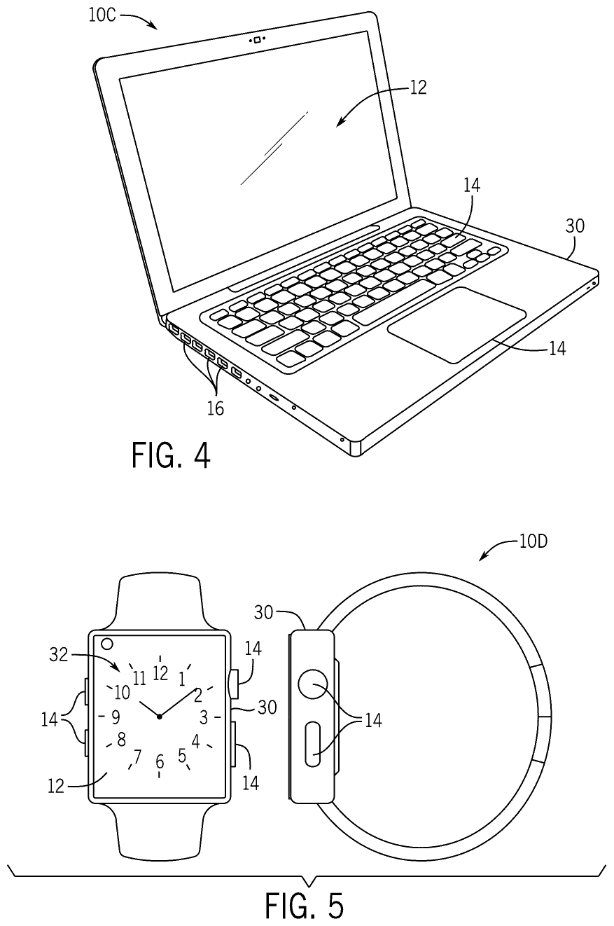

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

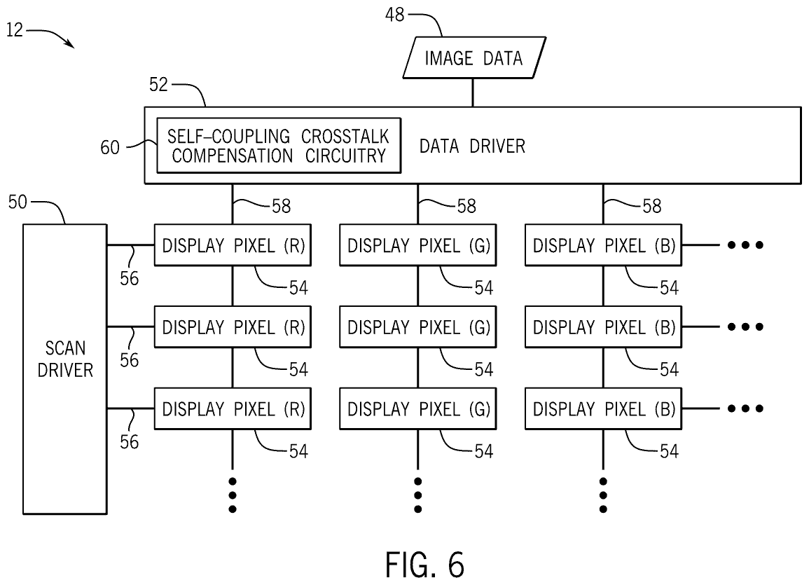

FIG. 6 illustrates one version of the electronic display 12 that may use pixel grouping to increase frame rates without consuming additional power and while preserving image quality. In FIG. 6, the electronic display 12 is shown as an electronic display 12 representing a liquid crystal display (LCD) or an organic light emitting diode (OLED) display. The electronic display 12 may receive image data 48 for display. The electronic display 12 uses display driver circuitry that includes scan driver circuitry 50 and data driver circuitry 52 to program the image data 48 onto display pixels 54. The display pixels 54 may each represent a liquid crystal (LC) cell to filter certain colors of light in various brightness levels from a backlight (not shown) or may contain one or more self-emissive elements, such as a light-emitting diodes (LEDs) (e.g., organic light emitting diodes (OLEDs) or micro-LEDs (μLEDs)). The display pixels 54 may also represent pixels of digital mirror devices (DMD) or other suitable display devices that may use pixel grouping. In any event, different display pixels 54 may emit different colors (e.g., red (R), green (G), blue (B), for an RGB display). For example, some of the display pixels 54 may emit red light, some may emit green light, and some may emit blue light. Thus, the display pixels 54 may be driven to emit light at different brightness levels to cause a user viewing the electronic display 12 to perceive an image formed from different colors of light. The display pixels 54 may also correspond to hue and/or luminance levels of a color to be emitted and/or to alternative color combinations, such as combinations that use cyan, magenta, and yellow (CMY), or others.

The scan driver 50 may provide scan signals (e.g., pixel reset, data enable, on-bias stress, scan, data sampling) on scan lines 56 to activate the display pixels 54 by row. For example, the scan driver 50 may cause one or more selected rows of the display pixels 54 to become enabled to receive a portion of the image data 48 from data lines 58 from the data driver 52. As used herein, the portion of image data 48 received by display pixels 54 may be referred to as “image data” or “pixel data.” An image frame of image data 48, containing pixel data for the display pixels 54, may be programmed onto the display pixels 54 row by row or selected groups of rows. Because each column of the display pixels 54 may share one data line 58, it is possible that self-coupling from the data line 58 to a display pixel 54 could occur even when that display pixel 54 for some period of time after the display pixel 54 is no longer activated. As such, the display driver circuitry (e.g., the data driver 52) may include self-coupling cross talk compensation circuitry 60 to adjust the image data before it is programmed into the display pixels 54. The self-coupling cross talk compensation circuitry 60 may apply an adjustment in a linear, gamma domain, or a voltage domain of the image data 48. After adjustment, when programmed into the display pixels 54, image artifacts due to self-coupling cross talk may be reduced or eliminated. While the self-coupling cross talk compensation circuitry 60 is shown in FIG. 6 as a component of the display driver circuitry of the electronic display 12, in other examples, the self-coupling cross talk compensation circuitry 60 may be disposed in other circuitry, such as image processing circuitry (e.g., a display pipeline) associated with the processor core complex 18.

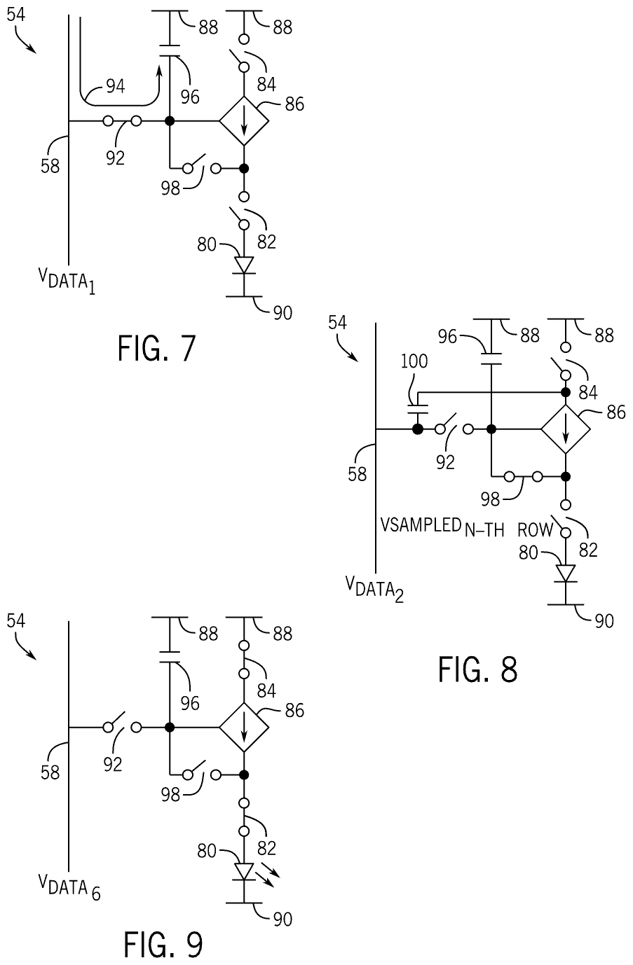

FIGS. 7-9 illustrate one mechanism by which self-coupling cross talk may affect a display pixel 54. FIG. 7 illustrates the programming of a display pixel 54, FIG. 8 illustrates self-coupling that may occur after the display pixel 54 is programmed but before the display pixel 54 enters an emission period, and FIG. 9 illustrates the operation of the display pixel 54 during an emission period. The display pixel 54 includes a light-emissive element 80 (e.g., an OLED or micro-LED). Switches 82 and 84 selectively couple pixel drive circuitry 86 to a voltage source 88 (e.g., a positive voltage supply) and the light-emissive element 80, which is coupled to a voltage source 90 (e.g., a negative voltage supply, ground). As shown in FIG. 7, a switch 92 allows the display pixel 54 to sample a voltage 94 corresponding to the pixel data being provided on the data line 58 (e.g., Vdata1) onto a storage capacitor 96. A switch 98 selectively allows a threshold voltage of the pixel drive circuitry 86 to be sampled to account for variations in pixel drive circuitry 86 among the different display pixels 54.

At a subsequent point in time, shown in FIG. 8, the switch 92 is open and the switch 98 is closed. At this point, a different row of display pixels 54 is being programmed, and thus the data line 58 is carrying pixel data (e.g., Vdata2) for a different display pixel 54. Even so, a parasitic capacitance 100 between a node between the switch 84 and the pixel drive circuitry 86 may result in a variation in the charge stored on the storage capacitor 96. The amount of charge may vary depending on the pixel data (e.g., Vdata2) for the different display pixel 54. During an emission period at a later time, shown in FIG. 9, the switches 92 and 98 are open and the switches 82 and 84 are closed. However, due to the wrong voltage remaining on the storage capacitor 96 due to the self-coupling cross talk illustrated in FIG. 8, the pixel drive circuitry 86 may emit an incorrect amount of current and, correspondingly, the light-emissive element 80 may emit an incorrect amount of light.

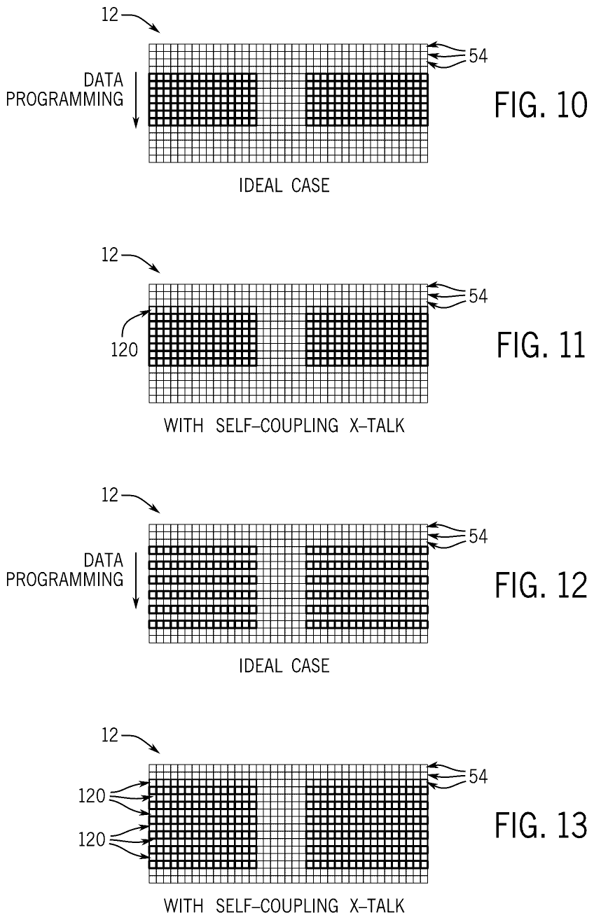

This effect is illustrated by two examples, a first of which appears in FIGS. 10 and 11 and a second of which appears in FIGS. 12 and 13. FIG. 10 illustrates an ideal case in which pixel data of the image data on the electronic display 12 is programmed into the display pixels 54 and there is no self-coupling cross talk due to shared data lines. FIG. 11, however, illustrates when the pixel data is programmed into the display pixels 54 of the image data and there is self-coupling cross talk. As a result of the change in pixel data from row to row along some columns, there may be a dim row 120. This effect may be even more dramatic with certain patterns of image data, such as shown in FIGS. 12 and 13. FIG. 12 illustrates another ideal case in which pixel data of the image data on the electronic display 12 is programmed into the display pixels 54 and there is no self-coupling cross talk due to shared data lines. FIG. 13, however, illustrates a case when the pixel data is programmed into the display pixels 54 of the image data and there is self-coupling cross talk. Because this example has multiple rows of alternating brightnesses defined by the pixel data for the various display pixels 54 of many of the columns, numerous dim rows 120 may appear.

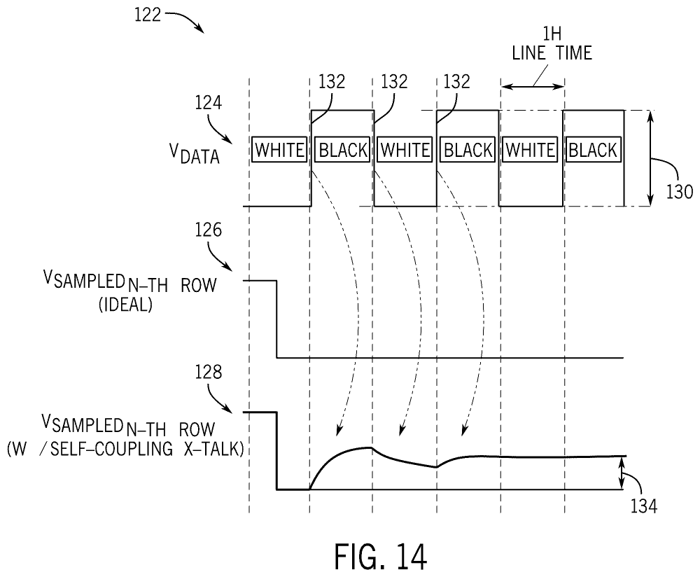

A timing diagram 122 shown in FIG. 14 illustrates this phenomenon. The timing diagram 122 shows that pixel data stored in one display pixel is believed to be affected by charge from pixel data used to program subsequent rows of display pixels. A first plot 124 shows pixel data that is programmed into display pixels, one at a time, on subsequent rows that are coupled to a single data line. The pixel data for a display pixel on row “n” is white (full brightness, low voltage), pixel data for a display pixel on row “n+1” on a subsequently programmed row on the same data line is black (no light, high voltage), pixel data for a display pixel on row “n+2” on a subsequently programmed row on the same data line is white (full brightness, low voltage), and so on. A second plot 126 illustrates an ideal case for the display pixel on the row “n,” in which the sampled voltage remains exactly equal to the pixel data for the row “n” shown in the first plot 124 (here, full brightness, low voltage). A third plot 128 illustrates an actual case in which for the display pixel on the row “n,” in which the sampled voltage changes due to the new pixel data on the same data line for subsequent rows. Here, due to a voltage swing 130 at transitions 132, the voltage value in the third plot 128 is pulled up during the programming of the display pixel on the “n+1” row, pulled down (but not all the way back down) during the programming of the display pixel on the “n+2” row, pulled up again (but not as far as the first time) during the programming of the display pixel on the “n+3” row, and so on. Indeed, the self-coupling effect diminishes as the voltage on display pixel on row “n” have effectively settled (e.g., subsequent changes would substantially not produce visually apparent artifacts) after some number N rows of display pixels on the shared data line have been programmed. The number N may be determined empirically or using computer modeling. For example, the number N may be greater than 0, greater than 1, greater than 2, greater than 3, greater than 4, and so on, depending on the characteristics of the electronic display 12.

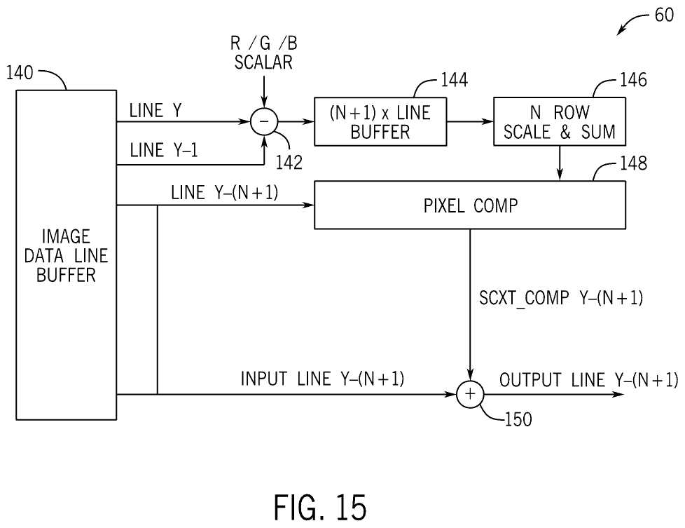

The self-coupling cross talk compensation circuitry 60 may reduce or eliminate image artifacts like these. Indeed, as shown by FIG. 15, the self-coupling cross talk compensation circuitry 60 may adjust the pixel data corresponding to the display pixels to preemptively account for self-coupling that is expected to occur due to subsequent pixel data that will be carried by a data line after each display pixel is programmed. For each display pixel, the self-coupling cross talk compensation circuitry 60 may determine a pixel data adjustment. For ease of explanation, the display pixel that is being adjusted by the self-coupling cross talk compensation circuitry 60 may be referred to herein as a “target display pixel” and the pixel data associated with it as “target pixel data.”

Recall that, as illustrated in FIG. 14, a display pixel on row “n” may be affected by self-coupling occurring due to pixel data for some number N rows after the display pixel on row “n” has been programmed. As such, the self-coupling cross talk compensation circuitry 60 may include an image data line buffer 140 to store the pixel data for the row “n” of the target display pixel plus N subsequently programmed rows. Thus, the total size of the image data line buffer may be N+1 lines. Differences between pixel data for display pixels on adjacently programmed rows (e.g., row y, row y−1) that the same data line may be calculated using difference circuitry 142. An R/G/B scalar may be applied based on whether the display pixel is a red (R), green (B), or blue (B) display pixel. This is because different colors of display pixels may have different properties.

The difference between the pixel data for display pixels that share the same data line on adjacently programmed rows may be stored in a second line buffer of size N+1. Recall from FIG. 14 that, for each target display pixel on row “n,” there may be N pixel data transitions that affect the pixel data stored on the target display pixel. Moreover, as illustrated in FIG. 14, subsequent transitions affect the target display pixel less and less at later-programmed rows. Therefore, N subsequent pixel data transition differences may be taken from the line buffer 144 and scaled according to when the pixel data transitions are to occur in relation to the target display pixel row and summed at N Row Scale & Sum circuitry 146. For example, the pixel data transition differences from row “n” to row “n+1” may be scaled to the greatest extent, the pixel data transition differences from row “n+1” to row “n+2” may be scaled less so, and so on for all N pixel differences. These scaled differences may be summed. This may also be referred to as a weighted sum of image data differences.

This weighted sum of image data differences may be used to index a pixel compensation lookup table (LUT) 148. The pixel compensation LUT 148 may be populated with lookup table entries corresponding to any suitable function that, based on the weighted sum of image data differences and the pixel data value of the target display pixel, returns a pixel data adjustment that compensates for the self-coupling effects due to pixel data on subsequently programmed display pixels sharing the same data line as the target display pixel. The pixel compensation LUT 148 may be populated based on a function determined from modeling or empirical experimentation of the behavior of the electronic display 12 when subject to various pixel data. Additionally or alternatively, processing circuitry may instead calculate the pixel data adjustment based on the function. For a target display pixel on row y−(N+1), the pixel data adjustment (SCXT_comp y−(N+1)) may be added to the pixel data for the target display pixel (Input Line y−(N+1)) in addition circuitry 150. The resulting adjusted pixel data (Output Line y−(N+1)) may be programmed into the target display pixel and, even after the subsequent N lines of display pixels on the same data line have been programmed, image artifacts due to self-coupling on the target display pixel may be reduced or eliminated.

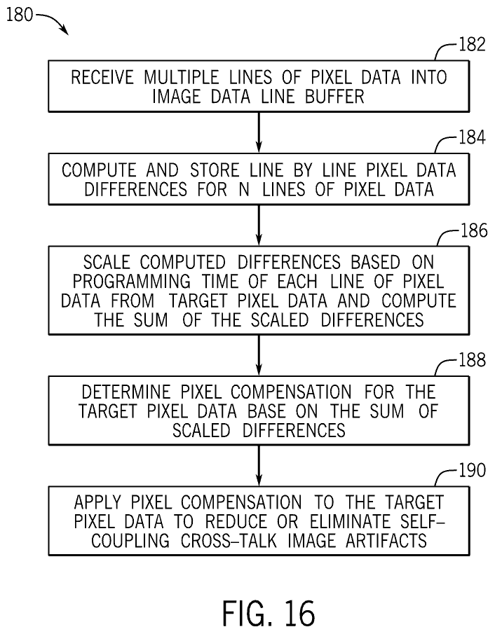

To summarize, as illustrated by a flowchart 180 of FIG. 16, the self-coupling cross talk compensation circuitry 60 may receive multiple (e.g., N+1) lines of pixel data into the image data line buffer 140 (block 182). Line-by-line pixel data differences may be sequentially computed in difference circuitry 142 and stored in a second line buffer 144 (e.g., sized N+1) (block 184). The pixel data differences may be scaled based on the programming time of each line in relation to the line of the target pixel data and these values may be summed (block 186). A pixel data adjustment to compensate for self-coupling effects may be determined based on the sum of the scaled pixel data differences using the pixel compensation lookup table 148 (block 188). The pixel data adjustment may be applied (e.g., added) to the target pixel data (block 190). When this compensated target pixel data is programmed into the target display pixel, after settling, the target display pixel may be substantially free of self-coupling cross talk image artifacts.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. An electronic display comprising:
an electronic display panel comprising lines and columns of display pixels, wherein each column of display pixels is coupled to a respective data line; and
display driver circuitry configured to adjust image data associated with the display pixels to account for coupling between the display pixels and the respective data lines.

2. The electronic display of claim 1, wherein the display driver circuitry is configured to adjust the image data based on image data differences associated with adjacently programmed display pixels coupled to the same respective data line.

3. The electronic display of claim 2, wherein the display driver circuitry is configured to adjust the image data based on a sum of a subset of the image data differences.

4. The electronic display of claim 3, wherein the display driver circuitry is configured to adjust the image data based on the sum of the subset of the image data differences scaled according to a programming time occurring after a target display pixel is to be programmed.

5. The electronic display of claim 1, wherein the display driver circuitry comprises a lookup table that outputs an adjustment value associated with a target display pixel based on a weighted sum of image data differences occurring on subsequent display pixels to be programmed after the target display pixel is to be programmed.

6. Image processing circuitry comprising:
an image data line buffer configured to store lines of image data corresponding to lines of display pixels of an electronic display;
difference circuitry configured to obtain an image data difference between pixel data of the image data associated with display pixels configured to be consecutively programmed via a shared data line; and
a pixel compensation lookup table configured to generate a pixel data adjustment corresponding to pixel data of the image data associated with a target display pixel based on the difference.

7. The image processing circuitry of claim 6, wherein the image data line buffer is configured to store N+1 lines of image data and the target display pixel is in the first line of the N+1 lines of image data in order of programming on the electronic display.

8. The image processing circuitry of claim 7, comprising an image data difference line buffer configured to hold N+1 lines of differences.

9. The image processing circuitry of claim 8, comprising scaling circuitry configured to apply a scaling factor to the differences from the image data difference line buffer based on a programming sequence of the image data that produced the differences.

10. The image processing circuitry of claim 7, wherein the number N is greater than 2.

11. The image processing circuitry of claim 6, comprising addition circuitry configured to add the pixel data adjustment to the pixel data of the image data associated with the target display pixel before the pixel data of the image data associated with the target display pixel is programmed into the target display pixel.

12. A method comprising:
receiving, into a buffer, first pixel data corresponding to a first display pixel of a first line coupled to a first data line of an electronic display;
receiving, into the buffer, second pixel data corresponding to a second display pixel of a second line coupled to the first data line of the electronic display;
determining a first pixel data compensation based at least in part on a difference between the first pixel data and the second pixel data; and
applying the first pixel data compensation to the first pixel data before the first pixel data is programmed into the first display pixel of the electronic display.

13. The method of claim 12, wherein determining the first pixel data compensation comprises scaling the difference between the first pixel data and the second pixel data based on a separation between the first line and the second line.

14. The method of claim 12, comprising receiving, into the buffer, third pixel data corresponding to a third display pixel of a third line coupled to the first data line of the electronic display;
wherein the first pixel data compensation is determined based at least in part on a difference between the second pixel data and the third pixel data.

15. The method of claim 14, wherein determining the first pixel data compensation comprises scaling the difference between the second pixel data and the third pixel data based on a separation between the second line and the third line.

16. The method of claim 12, wherein determining the first pixel data compensation comprises:
determining a sum of scaled differences comprising a sum of at least:
a first scaled difference corresponding to the difference between the first pixel data and the second pixel data scaled based on a separation between the first line and the second line; and
at least another scaled difference between first other pixel data and second other second pixel data, wherein the first other pixel data and the second other pixel data correspond to respective display pixels located on different lines and coupled to the first data line, scaled based on a separation between the different lines; and
selecting the first pixel data compensation from a lookup table indexed to the first pixel data and the sum of scaled differences.

17. The method of claim 12, wherein the method is performed in display driver circuitry of the electronic display.

18. An electronic device comprising:
first processing circuitry configured to generate image data; and
second processing circuitry configured to adjust the image data to compensate for coupling between display pixels and data lines of an electronic display.

19. The electronic device of claim 18, comprising the electronic display, wherein the electronic display comprises the second processing circuitry.

20. The electronic device of claim 19, wherein the second processing circuitry is a component of a display driver integrated circuit of the electronic display.

21. The electronic device of claim 18, comprising a processor core complex, wherein the first processing circuitry and the second processing circuitry are components of the processor core complex.

22. The electronic device of claim 18, wherein the second processing circuitry is configured to adjust the image data to compensate for the coupling between the display pixels and the data lines of the electronic display based on differences between the image data associated with adjacent display pixels that share the same data line.
